(19) United States
(12) Patent Application Publication
(10) Pub. No.: US 2005/0175794 A1
(43) Pub. Date: Aug. 11, 2005

(54) Using multilayer thermoformable sheetstock and/or films to form body panels

(76) Inventor: Paul J. Dathe, Plymouth, MN (US)

Correspondence Address: Kagan Binder PLLC, 221 Main St N Ste 200, 200 Maple Island Building, Stillwater, MN, 55082, US

(21) Appl. No.: 10/997,780

(22) Filed: Nov. 24, 2004

Related U.S. Application Data
(60) Provisional application No. 60/525,899, filed on Nov. 26, 2003.

(51) Int. Cl. B29D 24/00; B29C 43/02

(52) U.S. Cl. 428/31; 264/319

(57) ABSTRACT

The present invention relates to multi-layered, thermoformable body panels that can be incorporated into a wide range of motorized vehicles, and related methods. Preferably, the panels include a first layer having a polycarbonate material and a second layer having a pigmented polycarbonate material. Preferably, body panels are made by thermoforming sheetstock or film.

### PRIORITY CLAIM

The present non-provisional patent Application claims priority under 35 USC §119(e) from United States Provisional Patent Application having Ser. No. 60/525,899, filed on Nov. 26, 2003, by Dathe and titled USING MULTILAYER THERMOFORMABLE SHEETSTOCK AND/OR FILMS TO FORM BODY PANELS, wherein said provisional patent application is commonly owned by the owner of the present patent application and wherein the entire contents of said provisional patent application is incorporated herein by reference.

### FIELD OF THE INVENTION

The present invention relates to multi-layered, thermoformable sheetstock and/or films for making body panels that can be incorporated into a wide range of motorized vehicles, and related methods.

### BACKGROUND OF THE INVENTION

Currently, there are problems with the performance of body panels on motorized, off-road recreation and utility vehicles (snowmobiles, ATV's, motorcycles, etc.). These vehicles' body panels traditionally are injection molded with a single selected substrate polymer and are easily scratched, damaged or broken. Many of these injection-molded components are also post-secondarily processed (top coated or painted) for protection and visual enhancement which can be financially inefficient due to the cost of materials, distribution and transportation of parts, all of which can be further complicated by VOC regulations and environmental concerns. Paint and traditional injection molded materials in general do not have properties that withstand the performance needs of the consumer in this industry.

Thus, traditional injection molded parts pose many problems. Examples of problems include one or more of the following: Chemicals like gas and oil can damage parts, paint and printing; Dust, dirt, debris and other invasive substances easily scratch and compromise the visual quality of surfaces (i.e. ATV submerged in mud or washing with a dirty rag) (once damaged, paint and exposed unpainted injection molded component surfaces cannot be easily polished or repaired, if at all); High impact and collision can compromise surfaces and/or geometry by cracking and breaking body panels (components are especially vulnerable during cold weather); Painting and coating processes are expensive because they are separate processes, carried out after the injection molding process is completed; Paint and other coating processes produce waste, including air-born particulates, that must be appropriately handled to prevent environmental and health damage; Injection molding of large components requires large financial investments (this fact slows the cycle at which newly designed geometry can be introduced to the market. Thermoforming molds require lower capital investment than injection molds. Thus, less time is required to recoup investments); Heavy-weighted parts lower the horsepower to weight ratio. Injection molded parts, because of their inferior material properties, tend to weigh more than necessary, resulting in lower horsepower to weight ratios than consumers would prefer; and Injection molded parts may have geometry stresses because of material flow, viscosity, variable pressure, cooling rates, etc.

### SUMMARY OF THE INVENTION

With consideration to the demands on a body panel product, a company must ideally develop a performance material and a flexible manufacturing process that meet the specific needs of the consumer, as well as the industry's needs in financing and manufacturing. The multi-layered, thermoformed body panels of the present invention can satisfy many of such demands. The invention provides a highly flexible manufacturing and design process and an affordable, high quality and durable product that has high scratch, damage and fade resistance. If by some chance, the product does become scratched or marred, the product is easily repaired such as by the use of polishing compounds which will restore the body panel to “factory-new” in appearance.

The preferred body panel has been designed and engineered to meet the specific requirements of the user, customer, and industry. First, the material includes a polycarbonate containing topcoat that has UV barrier properties. These properties help to keep colorants from fading, help to maintain structural integrity of the material. This top coat also may have one or more additives to help provide scratch resistance to the top surface. The topcoat also gives the body panel a significantly higher DOI (Depth of Image) and Gloss Factor than a non-coated or paint coated surface. The protective lifespan of the topcoat is also much greater than that of paint or traditional surface coating, as the polycarbonate is many times thicker than paint, allowing it to be polished throughout the products lifetime without breaking through this topcoat.

The second layer is comprised of a general-purpose polycarbonate that has been pigmented to the consumer's specification. The pigment acts as the paint finish. The pigment is mixed into the material before extrusion, eliminating painting, surface finishing and airborne particles released into the atmosphere during these processes. This also eliminates the necessary need use and disposal of multiple hazardous materials.

To form preferred body panels, the sheetstock or films, as the case may be, is thermoformed and/or pressure formed onto a mold surface where it is allowed to cool. During this process of thermoforming and/or pressure forming, the sheet or film is introduced to heat, causing it to enter a semi-liquid state. The semi-liquid sheet is then fit over a mold cavity. The mold cavity can be male or female and have special assists, such as hydraulics, pneumatics, electrical motors, and/or vacuums to accompany a complex geometry form. The formed part is then brought to a fixture where all venting and perimeters can be trimmed to accommodate the geometry, componentry, and hardware of the vehicle. During the thermoforming and finishing processes, a very thin protective coating may be maintained on the outer surface of the product, to protect the surface from scratching or other damage. This protective film may be referred to as the slip or carrier sheet by those skilled in the art.

Of course, thermoforming is not the only suitable technique that is suitable to form body panels. Injection molding techniques are one exemplary alternative. For example, thin gauge material can be formed and “injection mold inserted” to save material and part costs. In-mold labeling technology can be used to print, e.g., screen-print, graphics onto the material before part forming and fabrication.

According to one aspect of the present invention, a method of making a motorized vehicle body panel includes the steps of: providing a thermoformable sheetstock comprising at least first and second layers, wherein at least one of the layers comprises a polycarbonate and wherein the second layer comprises a visually discernible surface characteristic and wherein the first layer is at least partially optically transparent and protectively overlies the second layer; and thermoforming the sheetstock into a vehicle body panel.

According to another aspect of the present invention, a method of marketing a sheetstock includes the steps of: providing a product line comprising at least one thermoformable sheetstock comprising at least first and second layers, wherein at least one of the layers comprises a polycarbonate, wherein the second layer comprises a visually discernible surface characteristic and wherein the first layer is at least partially optically transparent and protectively overlies the second layer; and marketing the product line in associating with information indicative of using the sheetstock to form a vehicle body panel.

According to another aspect of the present invention, a motorized vehicle body panel includes a thermoformed sheetstock comprising at least first and second layers, wherein at least one of the layers comprises a polycarbonate, and wherein the second layer comprises a visually discernible surface characteristic and wherein the first layer is at least partially optically transparent and protectively overlies the second layer.

According to another aspect of the present invention, a method of selecting thermoformable sheetstock for use in manufacturing a body panel includes the steps of: identifying a candidate thermoformable sheetstock based upon information comprising a criteria requiring that the sheetstock comprise at least first and second layers, wherein at least one of the layers comprises a polycarbonate, wherein the second layer comprises a visually discernible surface characteristic and wherein the first layer is at least partially optically transparent and protectively overlies the second layer; testing the sheetstock for performance as a body panel to obtain test data indicative of at least two of gloss, tensile strength, elongation, and initiation tear strength; and using information comprising the test data to determine whether to incorporate the sheetstock into a body panel as a marketer and/or a manufacturer.

According to another aspect of the present invention, a method of making a motorized vehicle body panel includes the steps of: providing a thermoformable sheetstock comprising at least first, second, and third film layers, wherein at least one of the layers comprises a polycarbonate and wherein the second layer comprises a visually discernible surface characteristic and has opposed major surfaces, wherein the first layer is at least partially optically transparent and protectively overlies at least one of the major surfaces of the second layer, and wherein the third layer comprises a heat deflecting characteristic and overlies at least the other major surface of the second layer; and thermoforming the sheetstock into a vehicle body panel.

According to another aspect of the present invention, a method of marketing a sheetstock includes the steps of: providing a product line comprising at least one a thermoformable sheetstock comprising at least first, second, and third layers, wherein at least one of the layers comprises a polycarbonate and wherein the second layer comprises a visually discernible surface characteristic and has opposed major surfaces, wherein the first layer is at least partially optically transparent and protectively overlies at least one of the major surfaces of the second layer, and wherein the third layer comprises a heat deflecting characteristic and overlies at least the other major surface of the second layer; and marketing the product line in associating with information indicative of using the sheetstock to form a vehicle body panel.

According to another aspect of the present invention, a motorized vehicle body panel includes a thermoformed sheetstock comprising at least first, second, and third layers, wherein at least one of the layers comprises a polycarbonate and wherein the second layer comprises a visually discernible surface characteristic and has opposed major surfaces, wherein the first layer is at least partially optically transparent and protectively overlies at least one of the major surfaces of the second layer, and wherein the third layer comprises a heat deflecting characteristic and overlies at least the other major surface of the second layer.

According to another aspect of the present invention, a method of selecting thermoformable sheetstock for use in manufacturing a body panel includes the steps of: identifying a candidate thermoformable sheetstock based upon information comprising a criteria requiring that the sheetstock comprises at least first, second, and third layers, wherein at least one of the layers comprises a polycarbonate and wherein the second layer comprises a visually discernible surface characteristic and has opposed major surfaces, wherein the first layer is at least partially optically transparent and protectively overlies at least one of the major surfaces of the second layer, and wherein the third layer comprises a heat deflecting characteristic and overlies at least the other major surface of the second layer; testing the sheetstock for performance as a body panel to obtain test data indicative of at least two of gloss, tensile strength, elongation, and initiation tear strength, a heat deflecting characteristic; and using information comprising the test data to determine whether to incorporate the sheetstock into a body panel as a marketer and/or a manufacturer.

According to another aspect of the present invention, a method of marketing a multilayer film or sheetstock product includes the steps of: sealing a multilayer film or sheetstock in an interior of a water proof package, wherein the film or sheetstock comprises a polycarbonate; and marketing the multilayer film or sheetstock in association with information indicative of using the film of sheetstock to make a body panel of a motorized vehicle.

According to another aspect of the present invention, a package includes: an environmental barrier having an interior; a nonambient atmosphere in the interior; and a thermoformable sheetstock or film in the interior, wherein the sheetstock or film comprises at least first and second layers, wherein at least one of the layers comprises a polycarbonate and wherein the second layer comprises a visually discernible surface characteristic and wherein the first layer is at least partially optically transparent and protectively overlies the second layer.

According to another aspect of the present invention, a method of making a body panel for a motorized vehicle includes the steps of: providing a package including: an environmental barrier having an interior; a nonambient atmosphere in the interior; and a thermoformable sheetstock or film in the interior, wherein the sheetstock or film comprises at least first and second layers, wherein at least one of the layers comprises a polycarbonate and wherein the second layer comprises a visually discernible surface characteristic and wherein the first layer is at least partially optically transparent and protectively overlies the second layer; removing the sheetstock or film from the package; and thermoforming the sheetstock or film to form a body panel of a motorized vehicle.

According to another aspect of the present invention, a method of making a motorized vehicle includes the steps of: thermoforming a multilayer, thermoformable sheetstock or film to form a body panel, wherein the sheetstock or film comprises a polycarbonate; and ultrasonically welding a surface of a vehicle component to a surface of the body panel.

According to another aspect of the present invention, a method of making motorized vehicle includes the steps of: determining information indicative of the ultrasonic conductivity of a motor vehicle component surface; selecting a multilayer, polycarbonate-containing thermoformable film or sheetstock based upon information indicative of an ultrasonic conductivity characteristic of a surface of the film or sheetstock; thermoforming the film or sheetstock to form a body panel of a motorized vehicle; and ultrasonically welding the component surface to the film or sheetstock surface.

According to another aspect of the present invention, a method of marketing a multilayer film or sheetstock includes the steps of: determining information indicative of the ultrasonic conductivity of a motor vehicle component surface; manufacturing a multilayer, polycarbonate-containing thermoformable film or sheetstock using information comprising criteria indicative of an ultrasonic conductivity characteristic of a surface of the film or sheetstock; and marketing the film or sheetstock for use to form a body panel of a motorized vehicle.

According to another aspect of the present invention, a method of making a motorized vehicle includes the steps of: thermoforming a multilayer, thermoformable composite to form a body panel, wherein the composite comprises a polycarbonate containing layer; and wherein the composite comprises a foam core layer.

According to another aspect of the present invention, a method of making motorized vehicle includes the steps of: providing a thermoformable composite comprising first and second exterior layers and a foam core, wherein at least one of the first layer, second layer and/or foam core comprises polycarbonate; and thermoforming the composite to form a body panel of a motorized vehicle.

According to another aspect of the present invention, a method of making a motorized vehicle includes the step of: thermoforming a multi-layer, thermoformable sheetstock or film to form a body panel, wherein the sheetstock or film comprises indicia interposed between first and second layers, wherein at least one of the layers comprises a polycarbonate and wherein the second layer comprises a visually discernible surface characteristic and wherein the first layer is at least partially optically transparent and protectively overlies the second layer.

According to another aspect of the present invention, a method of making a sheetstock or film includes the steps of: applying indicia onto a first sheetstock or film material comprising a polycarbonate; and laminating the first sheetstock or film to a second sheetstock or film in a manner such that the indicia is positioned between the sheetstocks or films, and wherein the sheetstock or film comprises indicia interposed between first and second layers, wherein at least one of the materials comprises a polycarbonate and wherein the second material comprises a visually discernible surface characteristic and wherein the first material is at least partially optically transparent and protectively overlies the second layer.

According to another aspect of the present invention, a method of making a body panel includes the steps of: applying indicia onto a surface of a sheetstock or film material; applying a fluid composition over the first surface; causing the fluid composition to solidify whereby a multilayer film or sheetstock is formed; optionally incorporating one or more additional layers into the multilayer film or sheetstock; and forming at least a portion of the multilayer film or sheetstock into a body panel of a motorized vehicle.

According to another aspect of the present invention, a method of making a motorized vehicle includes the steps of: forming a multilayer formable composite into a body panel, wherein the composite comprises a polycarbonate containing layer; and wherein the composite comprises a structured core layer.

According to another aspect of the present invention, a motorized vehicle body panel includes a formed multilayer composite comprising a structured core having opposed major surfaces, wherein at least first and second layers are provided on one of said major surfaces such that the second layer is more proximal to the core; wherein at least a third layer is provided on the other major opposed surface; wherein at least one of the first and second layers comprises a polycarbonate and wherein the second layer comprises a visually discernible surface characteristic and has opposed major surfaces, and wherein the first layer is at least partially optically transparent and protectively overlies at least one of the major surfaces of the second layer.

According to another aspect of the present invention, a sheetstock includes in the form of a multilayer composite comprising a structured core having opposed major surfaces, wherein at least first and second layers are provided on one of said major surfaces such that the second layer is more proximal to the core; wherein at least a third layer is provided on the other major opposed surface; wherein at least one of the first and second layers comprises a polycarbonate and wherein the second layer comprises a visually discernible surface characteristic and has opposed major surfaces, and wherein the first layer is at least partially optically transparent and protectively overlies at least one of the major surfaces of the second layer.

According to another aspect of the present invention, a motorized vehicle body panel includes a formed multilayer composite comprising a foam core having opposed major surfaces, wherein at least first and second layers are provided on one of said major surfaces such that the second layer is more proximal to the core; wherein at least a third layer is provided on the other major opposed surface; wherein at least one of the first and second layers comprises a polycarbonate and wherein the second layer comprises a visually discernible surface characteristic and has opposed major surfaces, and wherein the first layer is at least partially optically transparent and protectively overlies at least one of the major surfaces of the second layer.

According to another aspect of the present invention, a sheetstock includes in the form of a multilayer composite comprising a foam core having opposed major surfaces, wherein at least first and second layers are provided on one of said major surfaces such that the second layer is more proximal to the core; wherein at least a third layer is provided on the other major opposed surface; wherein at least one of the first and second layers comprises a polycarbonate and wherein the second layer comprises a visually discernible surface characteristic and has opposed major surfaces, and wherein the first layer is at least partially optically transparent and protectively overlies at least one of the major surfaces of the second layer.

### BRIEF DESCRIPTION OF THE DRAWINGS

FIG. 1 shows a perspective view of a stack of flat, precut sheetstock sheets.

FIG. 2 shows a perspective view of a roll of film.

FIG. 3 shows a schematic, cross-section of a two-layer, sheetstock according to the present invention.

FIG. 4 shows a schematic, perspective view of a laminated and/or co-extruded material according to the present invention.

FIG. 5 shows a schematic, perspective view of a coextrusion process for making a sheetstock or film according to the present invention.

FIG. 6 shows a schematic, cross-section of a sheetstock or film according to the present invention incorporating printed indicia.

FIG. 7 shows a schematic, cross-section of a sheetstock or film according to the present invention incorporating printed indicia.

FIG. 8 shows a schematic, cross-section of a body panel according to the present invention having a heat deflecting layer printed thereon.

FIG. 9 shows a schematic, cross-section of a body panel according to the present invention having a heat resistant layer coextruded thereto.

FIG. 10 shows a schematic, cross-section of a body panel according to the present invention in the form of a foam core composite.

FIG. 11 shows a schematic, cross-section of twin-sheet, thermoformed components according to the present invention.

FIG. 12 shows a schematic, cross-section of a panel according to the present invention including a layer of adhesive formed on the faying surface.

FIG. 13 shows a schematic, perspective view of an exemplary composite embodiment of the present invention including a structured, honeycombed core.

FIG. 14 shows a package of sheetstock or film according to the present invention in a protective package.

### DETAILED DESCRIPTION

Body panels of the present invention can be incorporated into a wide range of motorized vehicles. These include personal watercraft, boats, snowmobiles, motorcycles, automobiles, engine and motor housings, all terrain vehicles (known commonly as ATV's), motor homes, trucks, racecars, bicycles and the like. Body panels of the invention are most advantageously used in recreational motorized vehicles such as snowmobiles, personal watercraft, etc. as performance demands upon body panels for such vehicles are especially stringent in terms of multiple specifications including impact resistance, gloss and gloss retention, light weight, abrasion resistance, solvent resistance, weather-ability, re-polish-ability, print-ability, etc.

Depending upon the manner in which the invention is to be practiced, the material from which a body panel is formed may be in the form of sheet-stock and/or film. The term sheet-stock as used in the thermoforming field means a precut, individual sheet in a variety of sizes that is distributed flat, usually in a stack. In preferred embodiments, sheetstock is sufficiently rigid such that any two distal corners (the two unheld corners) of a 2′ by 4′ panel when held at any two proximal corners (i.e., the two corners being held) sag below horizontal by a vertical displacement that is less than about 12 inches, preferably less than about 6 inches.

The term film as used in the thermoforming field means a thin layer of material that is traditionally stored or packaged in roll form after converting (Converting is the term used in the industry when an extruder or laminator converts plastic pellets to a sheet or film). In a preferred embodiment, film means a material whose distal corners of a 2′ by 4′ sample sag from the horizontal by more than about 12″ when held at proximal corners that are 2′ apart. Film stock is sometimes referred to as roll stock. Note that some modes of practicing this invention are preferably carried out with sheet-stock, film, or both as expressly noted herein.

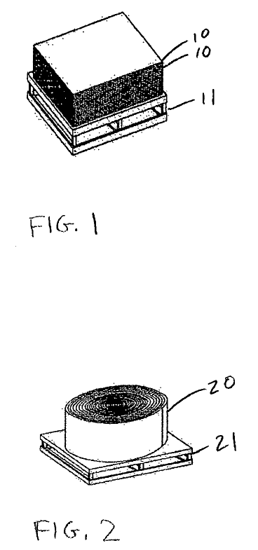

FIGS. 1 and 2 schematically compare sheetstock to film. FIG. 1 shows a stack of flat, precut sheetstock sheets 12 on a pallet 11. FIG. 2 shows a roll of film 20 on a pallet 21.

Film material already made may be converted to sheetstock by laminating to other material, adding additional layers via coating techniques, cutting, slitting, etc.

Also depending upon the manner in which the invention is to be practiced, the material from which a multilayer body panel is formed preferably may be co-extruded and/or laminated. Note that some modes of practicing this invention are preferably carried out with co-extrusion, laminating, or both, as expressly noted herein. The term “Co-Ex” refers to co-extruded material. The term “laminated” used in the thermoforming field means adhering two or more structures together, typically with a laminating adhesive, but some lamination may be done without the use of adhesives by laying a web of material directly to the surface of the film, or sheet and then drying, curing, or otherwise solidifying the web layer. When laminating, you are bringing at least two, sometimes dissimilar, materials together with an adhesive. Laminating is especially desirable when these materials have different molecular compositions and processing needs. These adhesives can be pressure sensitive adhesives, heat activated (thermal activated) adhesives, solvent-based adhesives, and in some cases energy, e.g., ultra violet, activated adhesives. These adhesives can be any suitable type, but preferably are acrylic, epoxy, and/or urethane. In any case, the adhesive advantageously is used to bond two or more materials together that have dissimilar characteristics such as differences in molecular shape, crystalline form, amorphous characteristics, hydrophilicity or hydrophobicity, surface energy, or the like. Surface treatment may be used to enhance adhesive characteristics of a surface. An example of a surface treatment is corona treatment. Chemical treatments or physical surface modifications also may be used.

A preferred embodiment of multilayer film used in some aspects of the invention is a two-layer, co-extruded film has been publicized by the General Electric Company (GE) under the trade designation SOLLEX. This film has a number of desirable characteristics: High impact strength, gloss retention, U.V. stability, color shift stability, chemical resistance, and scratch resistance. This commercially available film is also being promoted for use of back fill with injection molding technology. In accordance with the present invention, this film may be advantageously modified into sheetstock form by increasing the thickness of one or both layers, making it very suitable for being thermoformed into body panels having excellent structural integrity and other performance characteristics even without additional back filling or other reinforcement. The film alternatively may be modified by incorporating one or more additional layers, e.g., heat deflecting material, foam, printing, etc., into the structure. Specific properties of this film include the following:

| | |
|---|---|
| Tg (° C.) | 145 |
| MFI (300° C./1.2 kgf) | 3.2 |
| Notched Izod Impact (ft-lb/in) | 14.6 |
| Dynatup (ft-lb) | 57 |
| Tensile Strength (psi) | 11,000 |
| Tensile Elongation (%) | 100 |
| Density (g/cm) | 1.261 |
| CTE (40° C. to 90° C.) (m/m ° C.) | 6.8 × 10 − 5 |
| Refractive Index | 1.603 |

Extremely high gloss (>100 @ 60° F.).
Excellent gloss and color retention (10-Year Accelerated Outdoor Weathering Tests).
Available in metallic colors and visual effects.
Excellent resistance to gasoline and other chemicals.
Improved surface hardness versus other plastics.
Good scratch and mar resistance.
Easy to repair scratches (polishing compounds with buffing may help to return the body panels to “like-new” appearance).

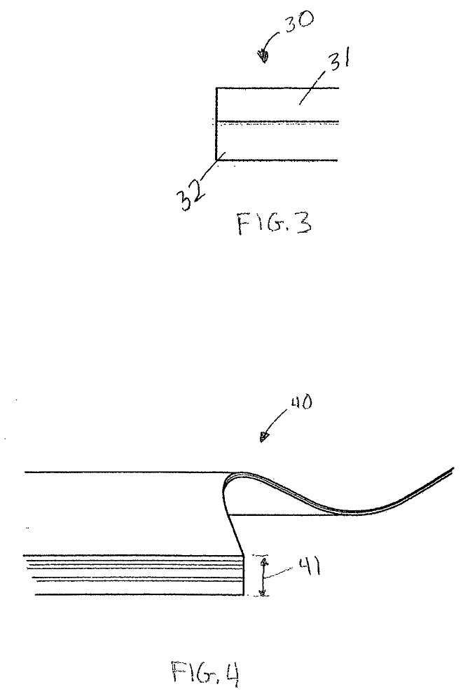

One preferred aspect of the invention involves using multiple layer, thermoformable sheet-stock to form panels. FIG. 3 schematically shows a cross-section of a preferred embodiment of a two-layer, sheetstock 30 as being a representative embodiment of sheetstock material useful to form body panels of the invention.

As shown in FIG. 3, the material (sheet or film) 30 includes a first layer 31 that generally will face toward the outside of the resultant body panel, while the second layer 32 generally will face inward (closest to the center of the machine). The second layer 32 will include at least one visually discernable characteristic, such as one or more colors, graphic indicia, alphanumeric indicia, surface texture, etc. Most preferably, the second layer 32 incorporates a coloring agent into the layer as, consequently, there is no need to paint the resultant body panel.

The first layer 31, which protectively overlies the second layer 32, is at least partially optically transparent to allow the second layer 32 to be viewed through the first layer 31. In preferred embodiments, the second layer 32 incorporates a colorant (pigment(s) and/or dye(s)) and thus functions as what otherwise could be a merely painted surface, while the first layer 31 functions as a protective, preferably glossy, topcoat/clear-coat that protects the second layer 32, enhances structural integrity of the panel, and provides excellent DOI (Depth of Image) and gloss factor. This first layer 31 will also give a longer life of protection to the component because of the thickness of the material vs. merely painted surfaces. Its life expectancy outsurpasses paint by being able to polish it multiple times without running out of material to polish.

The thermoformable, sheetstock characteristics of the material 30 are clear advantages. Unlike film, the sheetstock 30 will tend to have enough structural integrity to be thermoformed and then used directly, if desired, as a body panel without having to take an extra step of backfilling via injection molding or other suitable backfilling technique.

At least one of the second 32 and first 31 layers incorporates a polycarbonate for strength and impact resistance, among other advantages. More preferably, each of the second 32 and first 31 layers includes a polycarbonate, as is shown in the sheetstock cross-section shown in FIG. 3. Polycarbonate embodiments in particular are surprisingly durable. Other polymer materials and optional additives may also be used in combination with the polycarbonate in the same layer or in a different layer. Other polymers include polyurethane, polyester, polyethylene, polypropylene, polyamide, polyimide, poly(meth)acrylic polymers, vinyl polymers (ABS, HIPS, etc.), polyolefin's, fluoropolymers, silicone materials, combinations of these, and the like. Additives include one or more of organic or inorganic fillers, antioxidants, UV stabilizers (advantageously used at least in the first layer 31 to improve protection against the sun), coloring agents, fungicides, bactericides, foaming agents, antistatic agents, slip agents, etc. For body panels used near engines or other heat sources, the materials desirable are sufficiently heat resistant as appropriate.

Preferably, at least the first layer 31 incorporates ingredients such as one or more u.v. stabilizers to help provide the first layer 31 with u.v. stabilizer characteristics. This helps to keep colorants in the underlying second layer 32 from fading and also helps to maintain the structural integrity of the panel over time.

The two-layer material 30 and the individual layers 32 and 31 may have one or more desirable physical characteristics, such as:
Higher impact resistance. (Mechanical)
Higher Cold and Warm weather impact resistance. (Mechanical and Thermal)
Longer Impact resistance after U.V. exposure. (Mechanical)
Higher scratch resistance. (Mechanical)
Higher ease in repairing scratches. (Physical)
Higher gloss factor and depth of image. (Optical)
Higher color fade resistance (Optical)

Representative, preferred mechanical properties of each of the second 32 and first 31 layers may be:
Tensile strength yield>8,500 psi (ASTM D-882)
Tensile strength brake>10,000 psi (ASTM-D882)
Elongation>130% (ASTM-D-882)
Fold Endurance—with stand>150 double fold repitions (M.I.T.)

Thermal
Heat Distortion>300 degrees F. at 50 psi (ASTM-D-1637)

Optical
Yellowness Index<1.0 (ASTM-D-1925)
Light Transmission>85% (ASTM-D-1003)

Physical
Scratch Hardness>B (ASTM-D3363)

The two-layer material 30 may be a laminate in which two layers 32 and 31 are first formed independently and then are bonded together (adhesive not shown). Alternatively, the two layers 32 and 31 may be formed via co-extrusion. In either case, pigment is advantageously mixed into the raw materials used to make the second layer 32 before it is formed. The pigment acts as part or all of the desired paint finish. Incorporating the pigment into the second layer thus eliminates, if desired, additional painting/surface finishing. Multiple color options and styles can be offered.

Advantageously, airborne particles, vapor, etc. that might otherwise be associated with painting and surface finishing are avoided. Not only does this enhance worker safety, but it also eliminates the disposal and use of hazardous materials that often are leftover or are created during the course of painting or surface finishing.

Co-extruded sheetstock or a laminate having the preferred structure and polycarbonate composition described herein gives a manufacturer the ability to achieve great scratch resistance and extreme high gloss properties without having to paint. Extrusion and lamination processing also give a manufacturer the ability to add metallic flake to color, and the ability to produce multiple color per-side options that are not achievable with injection molding. Of course, the sheetstock material of the invention also may be used in conjunction with injection molding in some modes of practice, but it is a distinct advantage that the sheetstock may be thermoformed into body panels with excellent structural integrity without having to resort to injection molding operations after thermoforming.

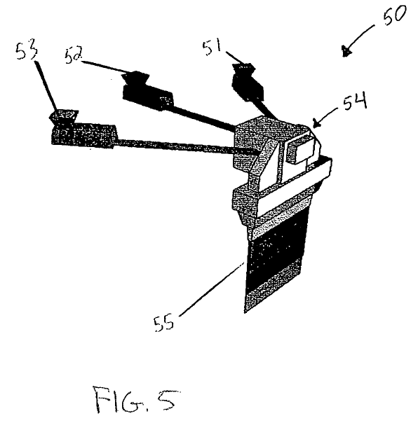

FIG. 4 shows a laminated and/or co-extruded material 40 with an edge of the material shown schematically in cross-section not to scale. Material 40 can have a thickness 41 in the range from 0.010 inches to 0.1875 inches.

The preferred, sheetstock including at least the two layers 32 and 31 described preferably is thermoformed to form at least a portion of a body panel. Depending upon the nature of the panel or panel part being formed, the thermoformed material may be brought to a fixture or other suitable workstation where all venting and perimeters can be trimmed to accommodate the geometry, componentry, and hardware of the design. Sheetstock is often supplied with a thin, protective, thermoformable, and disposable film. This film is desirably left in place at least until after such trimming is completed.

The thermoform process gives manufacturers low tooling capital expense, which drives down part costs and increases availability of design geometry changes. More products can be offered for less investment than if injection molding were to be used. In one view, for the same or less investment, a manufacturer can offer a larger spectrum of product offerings.

To sum up one preferred aspect of the invention, the invention offers a body panel solution in which a multi-layered, preferably Co-Extruded sheetstock is thermoformed and trimmed or die cut to form the panel. In the Thermoform process, the sheet is introduced to a mold under heat, where it becomes semi-liquid in form. The semi-liquid form is stretched over a mold cavity that may be male or female and can have special assists for its geometry. Hydraulics, pneumatics, electrical motors, vacuum, and pressure, etc. may be used to assist in the introduction of the semi-liquid material to the surface of the mold.

Advantages include one or more of the following:
Higher Scratch resistance than a current (ATV/Snowmobile/Motorcycle) body panel component in the market.
Higher gloss factor than a current (ATV/Snowmobile/Motorcycle) body panel component in the market.
Higher DOI (depth of image) than a current (ATV/Snowmobile/Motorcycle) body panel component in the market.
Higher UV resistance to color change than a current (ATV/Snowmobile/Motorcycle) body panel component in the market.
Higher UV resistance (with regard to the life of) and impact resistance than a current (ATV/Snowmobile/Motorcycle) body panel component in the market.

Lighter weight (e.g., ½ the weight) of a current (ATV/Snowmobile/Motorcycle) body panel component in the market.
Higher cold weather impact resistance (up to −40° F.) than a current (ATV/Snowmobile/Motorcycle) body panel component in the market.
Increased frequency of design geometry changes (from year to year)
Increased shape and geometry options for custom applications (i.e. Racing snowmobiles, Mountain snowmobiles, Sport edition ATVs, etc. . . . )
Consumer Satisfaction
Higher quality components
Longer life of components (e.g., up to 10 year color and impact resistance)
Reduced Cost of replacement or enhancement components vs. factory Cost.
Increased vehicle performance due to weight reduction (i.e. “Horsepower to Weight” ratio)
Company Satisfaction

Sheet extrusion is the process of converting feed(s) comprising plastic pellets or powder into cut sheets or rolls of plastic. This film or sheet can be further processed into parts via thermoforming. The sheet extrusion process most commonly can yield sheet products with thickness ranging from less than 0.010 in. (film) up to and exceeding 2.0 inch, with widths as great as 30 ft. Co-Extrusion is the combination of extruded sheet materials, two or more, into one sheet before the part is completely cooled or chilled.

The first polymer starts in a pellet form in an extruder, where the material is melted and pushed through a die, then chilled between two rollers. A second material is introduced by the same process simultaneously and is automatically bonded to the first material due to the melt index of the materials. The same happens for any other additional layers. It is possible to have multiple layers, even as many as 200 or more, to achieve maximum performance results for the desired application.

The multi-layered material is then transported for introduction to the Thermoforming process. The material can be transported by roll, sheet, or it can be formed while still in a semi-liquid state immediately after the extrusion process.

FIG. 5 schematically shows coextrusion 50 of three materials 51, 52, and 53 through extruder 54 to form a three-layered sheetstock or film 55.

Thermoplastic sheet 55 can be cut to custom sizes and shapes from sheet stock by striking the sheet 55 sharply with a shaped knife-edge known as a steel-rule die. Clicking and dinking are other names for die cutting of this kind. Die cutting in this manner can be used to clear holes in the part.

Thermoformed parts can also or alternatively be cut in a post-secondary process to custom sizes and shapes by the use of a computer-controlled milling machine and/or router. Exemplary cutting methods include laser cutting and water-jet cutting.

In some modes of practicing the invention, it may be desirable to incorporate more graphic, color, alphanumeric or other indicia into a thermoformed body panel in addition to that provided by the pigmented and/or dyed and/or otherwise colored second layer. This is advantageously accomplished by incorporating such indicia between the first and second layers so that the indicia is well protected.

Thermoplastic sheet can be printed using most commercial processes, including silk-screening, flexogravure and rotogravure printing, spraying, brushing, lithographic processes, and/or the like.

The present invention preferably carries out printing before the part is thermoformed, which gives the manufacturer the ability to add multiple colors with tight registration without the use of paint masking or templates. This process provides lower cost and is more durable than graphic water slip forming. In this application, printing may be added to the material on the inside or outside of the extrusion before the thermoforming process. Printing inks desirably are thermoformable so that printed images conform as the body panel is formed. Standard procedures innovatively borrowed from packaging allow calculations and allowances for the stretching and warping of graphics during the forming process. Images generally are printed or otherwise formed on flat sheet or film (although some printing processes work on non-flat surfaces), yet the body panel formed from the sheet will tend to be non-flat. Thus, the image printed on the flat sheet or film will tend to be distorted as a body panel is formed. One usually wants the image to look proper on the formed body panel. Consequently, a common process is to “map” the geometry and convert the image for flat printing in a manner so that the image will have the desired appearance after thermoforming. The results are perfect looking graphics or text, as good and even better in quality than that of traditional post-production printing. Because the graphics can be essentially sandwiched between the layers of plastic, it makes them highly durable in comparison to traditional printing. Optionally, printing may be incorporated into multilayer structures before all desired layers are formed. This allows durable printing to be well protected inside the structure while still being viewable.

Printing, for example, can be:

On the outside of the material.
On the inside between multiple layers before laminating, coating, and or co-extruding is completed.
Outside the material on the non-exposed material side when the part is completely translucent or semi-translucent.
Outside the material on the non-exposed material side when the part is completely translucent or semi-translucent additional material is injection molded around or behind the part. This leaves the printed image in the middle of the part and exposed to either the finished side and/or the non-finished side (the injection-molded side).

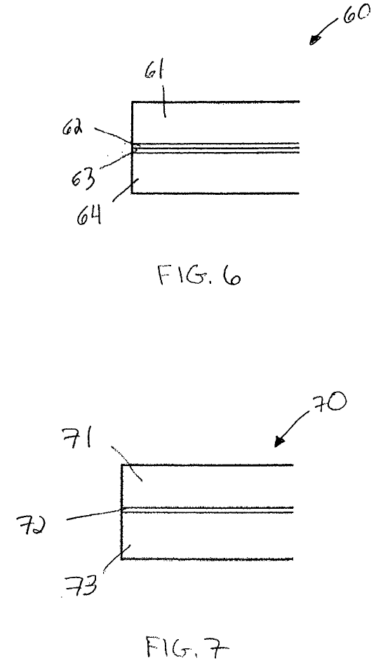

FIGS. 6 and 7 illustrate embodiments of the invention incorporating printed indicia.

FIG. 6 is similar to the two layer sheetstock 30 described above with respect to FIG. 3, except for the following:
First, the multilayer structure 60 in FIG. 6 may be sheetstock or film; and
Second, some indicia, shown schematically as a printed, continuous layer (although in practice it may be continuous or discontinuous depending upon the indicia) 62 is applied onto the first layer 61 (preferably including polycarbonate as shown) via any suitable printing or other application technique;
Third, the modified first layer 61 is bonded to the second layer 64 (preferably including polycarbonate as shown) with an adhesive layer 63.

Advantageously, the resulting indicia 62 will be easily viewed through the first layer 61 when the resultant panel is formed, yet the indicia is well protected by the first layer 61.

FIG. 7 is similar to the two layer sheetstock 30 described with respect to FIG. 3, except for the following:
First, the multilayer structure 70 may be sheetstock or film; and
Second, some indicia, shown schematically as a printed, continuous layer 72 (although in practice it may be continuous or discontinuous depending upon the indicia) is applied onto the first layer 71 (preferably including polycarbonate as shown) via any suitable printing or other application technique;
Third, the second layer 73 is formed by a fluid coating technique of the desired formulation onto the printed first layer 71, after which the coating is dried, cured, etc. as appropriate.

Again, the printing is well protected, and the use of a separate adhesive is avoided.

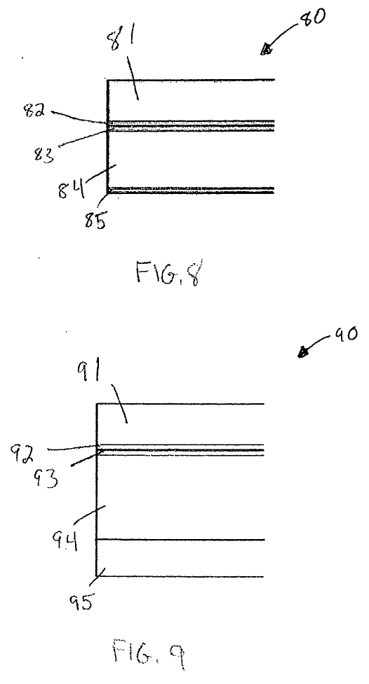

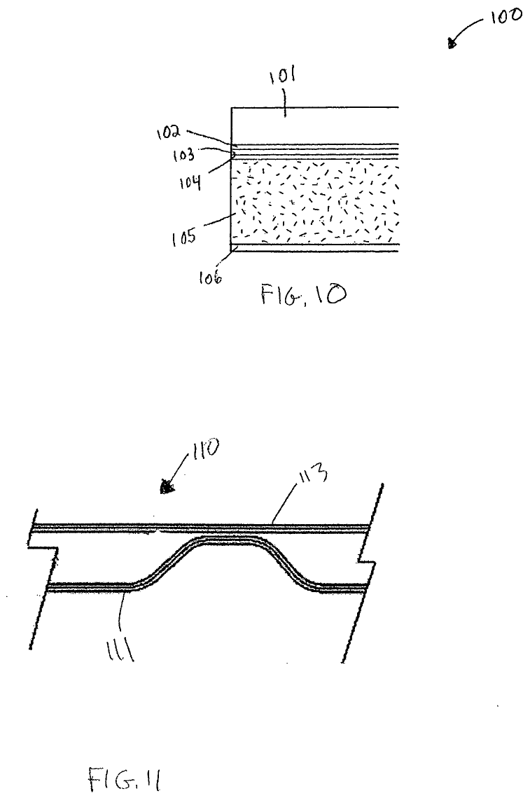

Panels of the invention may be used in environments in which the panel houses or otherwise is proximal to a heat source. For example, an engine housing panel will be near an engine, and thus the panel will be exposed to the engine heat. Using heat resistant materials is desirable, but heat resistance can be further increased by incorporating a heat deflecting layer into the body panel. Most desirably, the heat deflecting layer is positioned on the interior face of the panel that faces the heat source. FIGS. 8 and 9 illustrate such embodiments.

FIGS. 8 and 9 show representative embodiments of respective body panels 80 and 90 that are similar to the indicia-containing embodiment shown above except for each further comprising a heat deflecting layer 85 and 95, respectively. The heat deflecting layer of each embodiment is provided on the lower surface of the second layer corresponding to the interior face of the panel that might face a heat source. A typical heat deflecting layer may comprise a high temperature resistant polymer and/or suitably heat deflective, metal and/or ceramic containing surface or the like as now or hereafter conventionally known. Such a layer may be formed by laminating, printing or otherwise applying a suitable composition onto the second layer, via coextrusion, coating, laminating a metallized film, etc. The heat deflection layer will help reduce heat transfer or convection into the panel.

In FIG. 8, the heat deflecting layer 85 is printed onto the lower surface of the pigmented polycarbonate containing layer 84. Additional information 83 is printed onto the upper surface of the pigmented polycarbonate containing layer 84. The pigmented polycarbonate containing layer 84 is laminated to the top polycarbonate containing layer 81 with an adhesive 82. Usually, the printing 83 between the polycarbonated layers 81 and 84 is applied prior to laminating. The heat deflecting layer 85 may be printed before, during, or after laminating as desired.

Note in FIG. 9 that the heat resistant layer 95 and the pigmented polycarbonate containing layer 94 are coextruded. In the meantime, printing 92 is applied to the top polycarbonate layer 91. These two subassemblies are then laminated together using an adhesive 93 as shown.

Some applications require very strong, yet lightweight panels. Other applications may involve circumstances in which the geometry of the outer face of the panel is different from the interior panel face. In such instances, core composite embodiments of the invention are especially useful. These embodiments generally interpose a suitable core between the first and second layer. One or more optional layers, such as printing layers, adhesive layers, heat deflecting layers, etc., may further be included in the composite structure.

FIG. 10 shows such a panel 100 in the form of a foam core composite. This is similar to the embodiment of FIG. 9, except that a foam core 105 is included. Specifically, panel 100 includes polycarbonate layer 101, print layer 102, adhesive layer 103, pigmented polycarbonate layer 104, foam polycarbonate layer 105, and polycarbonate layer 106. The foam may be open or closed cell, depending upon the desired application. A preferred foam material comprises polycarbonate, polyurethane, polyvinyl chloride, polystyrene, high impact polystyrene, polyester, and/or other kinds of foam material may optionally be used. Please note FIG. 10 will be thermoformable. It has a thicker look, feel and performance including vibration resistance, but will not carry the weight and cost associative of a multilayer film or sheet that is of the same overall thickness, but otherwise not including the foam core 105. The foam core 105 also uses less material in the core as compared to an otherwise solid core made of the same material. This embodiment shown in FIG. 10 will perform with excellent properties associative of film geometry and will have strength due to an “I-beam” effect. Also note the foam layer 105 will have properties that can be higher in heat melt point due to the collapsing of the open or closed cell structure in the thermoforming process. If the foam layer 105 becomes too viscous in the forming process, it will collapse leaving an un-even wall thickness.

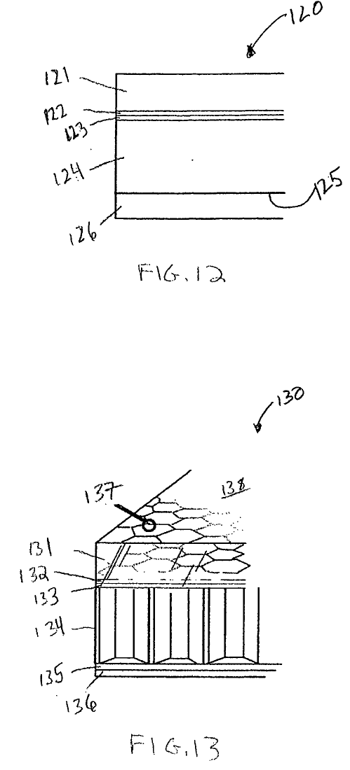

The following panel 110 in FIG. 11 shows how a foam core composite similar to the foam core composite 100 of FIG. 10 can be thermoformed, cold formed, or the like, to accommodate surface geometry differences between the exterior wall 113 and the interior wall 111. Interior wall 111 has a modified, nesting geometry to allow it to fit over or engage internal components (not shown) housed by the panel 110. The scale of the geometry modification depends upon the particular application. The composite is very strong yet much lighter than a comparable solid-filled material. Together, the components provide an excellent “I-Beam” effect.

In some modes of practice, it may be desirable both to thermoform the body panel material and to bond the panel to an underlying component. This may be accomplished in a variety of ways such as by screwing, nailing, stapling, glueing, welding, or the like. A particularly preferred approach involves providing the faying surfaces of the panel with adhesive characteristics. These characteristics may be provided by a pressure sensitive adhesive or by a hot melt adhesive. Such adhesives may be formed on the multilayer material via coating, coextrusion, laminating or the like.

For example, FIG. 12 shows such a panel 120 in which a layer of an adhesive 126 is formed on the faying surface 125 of the material. This is similar to the embodiment of FIG. 9, except that a hot melt adhesive layer 126 is included. Specifically, panel 120 includes polycarbonate layer 121, print layer 122, adhesive layer 123, pigmented polycarbonate layer 124 having surface 125, and adhesive layer 126. The adhesive layer 126 can comprise one or more hot melt adhesive materials and/or pressure sensitive adhesives such as linear low PP and or EVA depending upon the desired application. The adhesive could also contain one or more of urethane, (meth)acrylic and or epoxy. In a preferred embodiment, adhesive is laminated to the multilayer film or sheet stock. The material may be activated with heat, pressure, UV light, and/or will chemically react to an additive on the panel. This embodiment would be used when an existing body panel (possibly injection molded) needs more protection or needs special graphic representation (i.e. Patterns, Identity, foils, embossing, holographic, etc . . . ), or the like. To manufacture a body panel incorporating this embodiment, one may thermoform the embodiment into an appropriate shape or directly onto an existing component so as to fit onto such component (injection molded, stamped metal, etc.) A press shaped to the desired geometry will press this panel on the existing panel for adhesion using any combination of the above processes; heat, pressure, UV light to react or cure the polymer, thermoset reacting polymer. Also note if the adhesive temp meld point is lower or equal to the meld point of the film or sheetstock, this adhesive layer can be applied individually as a thermoform adhesive layer with a slip sheet, or could be applied by means of rolling, spraying, or the like. In another case the adhesive is a pressure sensitive adhesive where small balls containing encapsulated adhesive are broken to provide adhesive action. Rather than being applied to the underlying component, such adhesive forms may also be applied firstly to the film or sheet stock. If a pressure sensitive adhesive is used this embodiment could be applied by removing the release or backer film, if any, off the adhesive layer and applying the thermoformed shell by hand or machine. With geometry fitting so close and high amounts of surface area the pressure sensitive adhesive may work fine for a given application. If the thermoform shell has undercuts that “hug” the protected piece, less adhesive power may be needed due to geometry underlock.

Foam is not the only suitable core material. Other materials may be used. One exemplary class of alternative core materials include structured cores that may be honeycombed, fluted, corrugated (including so called “A” flutes or “S” flutes, etc.), or the like. When such cores incorporate one or more suitable, cold-formable materials such as polycarbonate, aluminum, titanium, magnesium, and/or the like, the resultant composite multilayered material may be cold formable as well to a desired shape without the use of heat. In some cases where heat or mold contact pressure is needed, such embodiments may benefit from a slip sheet protecting the surface finish of the part in contact with the mold surface(s). The overall thickness of the structured core from top to bottom may be selected from a wide range. If the core is too thick, the resultant material may be too hard to form in the desired manner. Extra thickness not needed for part integrity also makes the core more expensive. If too thin, though, the structural benefits of using a core material may not be realized as fully as might be desired. Balancing these concerns, an exemplary suitable core thickness top to bottom may be in the range from about 0.050 inches to about 0.250 inches, preferably about 0.010 inches to about 0.150 inches.

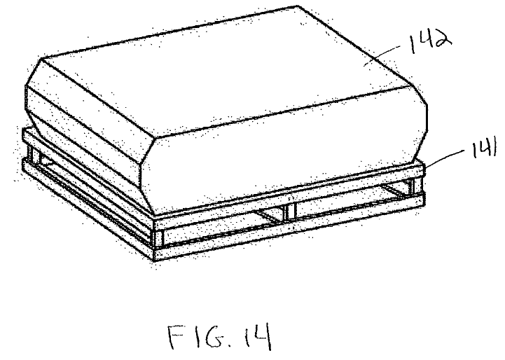

FIG. 13 shows an exemplary composite embodiment 130 including a structured, honeycombed core 134 having honeycomb structure 137. Specifically, embodiment 130 includes polycarbonate layer 131 having top surface 138, pigmented polycarbonate layer 132, adhesive layer 133, extruded support layer 135 having honeycomb structure 137, adhesive layer 135, and polycarbonate layer 136. The composite embodiment 130 can be thermoformed, cold formed, or the like, to accommodate surface geometry differences between walls. The structured core 134 may be an extrusion based material used as a lightweighting and strength insert that will serve as the “I” in the “I-Beam” effect. In preferred cases, the honeycomb walls of the extrusion may be a thin metal such as aluminum, titanium, or magnesium. The composite is very strong yet much lighter than a non-structured, solid core of comparable thickness made from the same material.

Sheetstock or film of the invention may tend to be hygroscopic. This means that the film or sheetstock may tend to absorb water from the ambient after it is manufactured and before it is formed into a body panel. Conventionally, the thermoforming entity will need to heat sheetstock or film in an oven to drive out the moisture content before the material should be thermoformed. If the moisture is not removed from the polycarbonate the moisture may tend to bubble in the film leaving imperfections. This prepping tends to be expensive and time consuming. Accordingly, it is preferred in the practice of the present invention to package sheetstock or film in a protective package that reduces the tendency of the material to absorb water moisture. FIG. 14 shows a package 142 of sheetstock or film in a protective package that reduces the tendency of the material to absorb water moisture. Package 142 is positioned on pallet 141.

FIG. 14 shows an example of a multilayer film or sheetstock in a protective package 142 for storage and/or distribution for moisture protection. The package 142 itself may have a multilayer construction including one or more layers such as HDPE, PVDC, PET, OPP, EVOH, and or foil, for moisture protection or suitably low WVTR (water vapor transmission rate). The package optionally may be gas flushed during packaging to reduce moisture content inside the package. Nitrogen and or CO₂ is preferred for such flushing. In the practice of the present invention, WVTR may be determined by in accordance with ASTM E 96. Using this test procedure, representative WVTR's for representative packaging materials are as follows:
ASTM E 96
WVTR
Poly Propylene=0.7 grams/24 h/100 in2/mil @95% F/90% RH
PolyEster=0.7
PVC=4
foil=0

In the course of manufacturing motor vehicles, the body panels may be attached to one or more other vehicle components. In some instances, attachment is made using screws, bolts, rivets, or other fasteners that penetrate partially or wholly through the body panel. These penetrations expose the cross section of the body panel to solvents, dirt, etc. With multilayer panel constructions, this can lead to delamination among layers or other damage. Accordingly, in some applications, e.g., body panels housing engines or other environments that are sources of solvents, oils, grease, dirt, etc., it is preferred to attach components to body panels in such a way that penetrations into the body panel by fasteners are minimized or avoided altogether. In combination with the multilayer films of the invention, ultrasonic welding is an excellent way to bond components to a body panel.

Acoustic conductivity characteristics of materials can impact the quality of ultrasonic bonding among materials. Thus, one mode of making a motorized vehicle involves determining information indicative of the ultrasonic conductivity of a motor vehicle component surface. Then, a multilayer, polycarbonate-containing thermoformable film or sheetstock is selected based upon information indicative of an ultrasonic conductivity characteristic of a surface of the film or sheetstock. The film or sheetstock is thermoformed to form a body panel of a motorized vehicle. Then, the component surface is ultrasonically welded to the film or sheetstock surface.

According to a preferred mode of marketing a multilayer film or sheetstock, information is determined that is indicative of the ultrasonic conductivity of a motor vehicle component surface. A multilayer, polycarbonate-containing thermoformable film is manufactured using information comprising criteria indicative of an ultrasonic conductivity characteristic of a surface of the film. The film is marketed for use to form a body panel of a motorized vehicle.

1. A method of making the motorized vehicle body panel of claim 14, comprising the steps of:
a) providing a thermoformable sheetstock or film comprising at least first and second layers, wherein at least one of the layers comprises a polycarbonate and wherein the second layer comprises a visually discernible surface characteristic and wherein the first layer is at least partially optically transparent and protectively overlies the second layer; and
b) thermoforming the sheetstock or film into a vehicle body panel.

2-6. (canceled)

7. The motorized vehicle body panel of claim 14, wherein the visually discernible characteristic comprises graphic information.

8-11. (canceled)

12. The motorized vehicle body panel of claim 14, wherein the motor vehicle is selected from an automobile, a truck, a marine vehicle, a snowmobile, a motorcycle, personal watercraft, engine and motor housings, all terrain vehicles (known commonly as ATV's), motor homes, trucks, racecars, bicycles and the like.

13. A method of marketing a sheetstock or film; comprising the steps of:
a) providing a product line comprising at least one thermoformable sheetstock or film comprising at least first and second layers, wherein at least one of the layers comprises a polycarbonate, wherein the second layer comprises a visually discernible surface characteristic and wherein the first layer is at least partially optically transparent and protectively overlies the second layer; and
b) marketing the product line in associating with information indicative of using the sheetstock or film to form the motorized vehicle body panel of claim 14.

14. A motorized vehicle body panel comprising a thermoformed sheetstock or film comprising at least first and second layers, wherein at least one of the layers comprises a polycarbonate, and wherein the second layer comprises a visually discernible surface characteristic and wherein the first layer is at least partially optically transparent and protectively overlies the second layer.

15. A motorized vehicle comprising the body panel of claim 14.

16-28. (canceled)

29. The motorized vehicle body panel of claim 31, wherein the third film layer comprises a metal-containing constituent.

30. (canceled)

31. The motorized vehicle body panel of claim 14 comprising a thermoformed sheetstock or film comprising at least first, second, and third layers, wherein at least one of the layers comprises a polycarbonate and wherein the second layer comprises a visually discernible surface characteristic and has opposed major surfaces, wherein the first layer is at least partially optically transparent and protectively overlies at least one of the major surfaces of the second layer, and wherein the third layer comprises a heat deflecting characteristic and overlies at least the other major surface of the second layer.

32. (canceled)

33. A method of marketing a multilayer film or sheetstock product, comprising the steps of:
a) sealing a multilayer film or sheetstock in an interior of a water proof package, wherein the film or sheetstock comprises a polycarbonate; and
b) marketing the multilayer film or sheetstock in association with information indicative of using the film of sheetstock to make a body panel of a motorized vehicle.

34. The method of claim 33, wherein the multilayer film or sheetstock comprises a thermoformable sheetstock comprising at least first and second layers, wherein at least one of the layers comprises a polycarbonate and wherein the second layer comprises a visually discernible surface characteristic and wherein the first layer is at least partially optically transparent and protectively overlies the second layer.

35. The method of claim 33, wherein the multilayer film or sheetstock is a thermoformable sheetstock comprising at least first, second, and third layers, wherein at least one of the layers comprises a polycarbonate and wherein the second layer comprises a visually discernible surface characteristic and has opposed major surfaces, wherein the first layer is at least partially optically transparent and protectively overlies at least one of the major surfaces of the second layer, and wherein the third layer comprises a heat deflecting characteristic and overlies at least the other major surface of the second layer.

36. The method of claim 33, wherein the package interior further comprises a nonambient atmosphere.

37. (canceled)

38. A package comprising:
a) an environmental barrier having an interior;
b) a nonambient atmosphere in the interior; and
c) a thermoformable sheetstock or film in the interior, wherein the sheetstock or film comprises at least first and second layers, wherein at least one of the layers comprises a polycarbonate and wherein the second layer comprises a visually discernible surface characteristic and wherein the first layer is at least partially optically transparent and protectively overlies the second layer.

39. A method of making a body panel for a motorized vehicle, comprising the steps of:
a) providing the package of claim 38;
b) removing the sheetstock or film from the package; and
c) thermoforming the sheetstock or film to form a body panel of a motorized vehicle.

40-42. (canceled)

43. A method of making a motorized vehicle body panel, comprising the steps of:
thermoforming a multilayer, thermoformable composite to form a body panel, wherein the composite comprises a polycarbonate containing layer; and wherein the composite comprises a foam core layer.

44. The method of claim 43, comprising the steps of:
a) providing a thermoformable composite comprising first and second exterior layers and a foam core, wherein at least one of the first layer, second layer and/or foam core comprises polycarbonate; and
b) thermoforming the composite to form a body panel of a motorized vehicle.

45. (canceled)

46. A method of making a sheetstock or film, comprising the steps of:
applying indicia onto a first sheetstock or film material comprising a polycarbonate;
laminating the first sheetstock or film to a second sheetstock or film in a manner such that the indicia is positioned between the sheetstocks or films, and wherein the sheetstock or film comprises indicia interposed between first and second layers, wherein at least one of the layers comprises a polycarbonate and wherein the second layer comprises a visually discernible surface characteristic and wherein the first layer is at least partially optically transparent and protectively overlies the second layer.

47. (canceled)

48. A method of making a motorized vehicle body panel, comprising the steps of:
forming a multilayer formable composite into a body panel, wherein the composite comprises a polycarbonate containing layer; and wherein the composite comprises a structured core layer.

49. A motorized vehicle body panel comprising a formed sheetstock of claim 50.

50. A sheetstock comprising in the form of a multilayer composite comprising a structured core having opposed major surfaces, wherein at least first and second layers are provided on one of said major surfaces such that the second layer is more proximal to the core; wherein at least a third layer is provided on the other major opposed surface; wherein at least one of the first and second layers comprises a polycarbonate and wherein the second layer comprises a visually discernible surface characteristic and has opposed major surfaces, and wherein the first layer is at least partially optically transparent and protectively overlies at least one of the major surfaces of the second layer.

51-52. (canceled)
